(19) United States
(12) Patent Application Publication
(10) Pub. No.: US 2020/0387806 A1
(43) Pub. Date: Dec. 10, 2020

(54) IDEA GENERATION SUPPORT DEVICE, IDEA GENERATION SUPPORT SYSTEM, AND RECORDING MEDIUM

(71) Applicant: KONICA MINOLTA, INC., Tokyo (JP)

(72) Inventor: Takumi KASEDA, Tokyo (JP)

(73) Assignee: KONICA MINOLTA, INC., Tokyo (JP)

(21) Appl. No.: 16/890,018

(22) Filed: Jun. 2, 2020

(30) Foreign Application Priority Data
Jun. 4, 2019 (JP) 2019-104145

(51) Int. Cl. G06N 5/02; G06N 20/00; G06F 40/35; G06F 40/56

(52) U.S. Cl. CPC G06N 5/022; G06N 20/00; G10L 15/265; G06F 40/56; G06F 40/35

(57) ABSTRACT

An idea generation support system includes a hardware processor configured to perform extracting at least one object from input data, obtaining a semantic vector having a direction and representing a meaning of the extracted object, based on the object, generating a semantic vector as a resultant vector having a direction different from the direction of the obtained semantic vector, by performing arithmetic processing based on the obtained semantic vector, and outputting output data indicating an object corresponding to the generated resultant vector.

### BACKGROUND

### 1. Technological Field

The present invention relates to an idea generation support device, an idea generation support system, and a recording medium.

### 2. Description of the Related Art

There are techniques (artificial intelligence, AI) that process a large amount of data using a computer to find rules, and learn from a large amount of data to recognize a pattern or to select the optimum solution based on the learning results. As various types of learning algorithms, such as neural networks in deep learning, have been improved and have achieved higher speed, these techniques have become available in a wider variety of fields.

Among techniques for text processing, there is a technique that accurately classifies words. Word2vec is a known technique that represents each word as a multi-dimensional vector, and quantitatively evaluates the similarity and the correspondence relationship. This technique also utilizes a leaning technique using a neural network. Word2vec is applied also to techniques for generating an appropriate answer sentence for a cause-and-effect question sentence, based on the correspondence relationship between a plurality of words (Japanese Patent Application Publication No. 2019-020893.

Meanwhile, as more and more simple tasks and routine tasks are being performed by machines using the above techniques, humans are now required to play a more creative role.

However, not everyone is good at generating new and specific ideas. Some people take a long time even to find a starting point for generating ideas, or cannot even find a start point.

### SUMMARY

An object of the present invention is to provide an idea generation support device, an idea generation support system, and a recording medium that provide the user with a starting point for generating ideas.

In order to achieve the above-described object, according to one aspect of the present invention, an idea generation support system includes:

a hardware processor configured to perform:

extracting at least one object from input data;

obtaining a semantic vector having a direction and representing a meaning of the extracted object, based on the object;

generating a semantic vector as a resultant vector having a direction different from the direction of the obtained semantic vector, by performing arithmetic processing based on the obtained semantic vector; and

outputting output data indicating an object corresponding to the generated resultant vector.

According to another aspect of the present invention, an idea generation support device includes:
a hardware processor configured to perform:
   extracting at least one object from input data;

obtaining a semantic vector having a direction and representing a meaning of the extracted object, based on the object;

generating a semantic vector as a resultant vector having a direction different from the direction of the obtained semantic vector, by performing arithmetic processing based on the obtained semantic vector; and

outputting output data indicating an object corresponding to the generated resultant vector.

According to still another aspect of the present invention, a non-transitory recording medium stores a computer-readable program, the program causing a computer to perform:

extracting at least one object from input data;

obtaining a semantic vector having a direction and representing a meaning of the extracted object, based on the object;

generating a semantic vector as a resultant vector having a direction different from the direction of the obtained semantic vector, by performing arithmetic processing based on the obtained semantic vector; and

outputting output data indicating an object corresponding to the generated resultant vector.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a block diagram illustrating the functional configuration of an idea generation support system according to an embodiment.

FIG. 2 illustrates a first example of processing that generates output data.

FIG. 3 illustrates a second example of processing that generates output data.

FIG. 4 illustrates a third example of processing that generates output data.

FIGS. 5A and 5B are diagrams each illustrating an example of the component amounts of multi-dimensional vectors.

FIGS. 6A and 6B are schematic diagrams each illustrating an example of conversion and combination of semantic vectors.

FIGS. 7A and 7B are diagrams illustrating an example of input and output image data.

FIG. 8 is a flowchart illustrating the control steps of an idea generation control process.

### DETAILED DESCRIPTION OF EMBODIMENTS

Hereinafter, one or more embodiments of the present invention will be described with reference to the drawings. However, the scope of the invention is not limited to the disclosed embodiments.

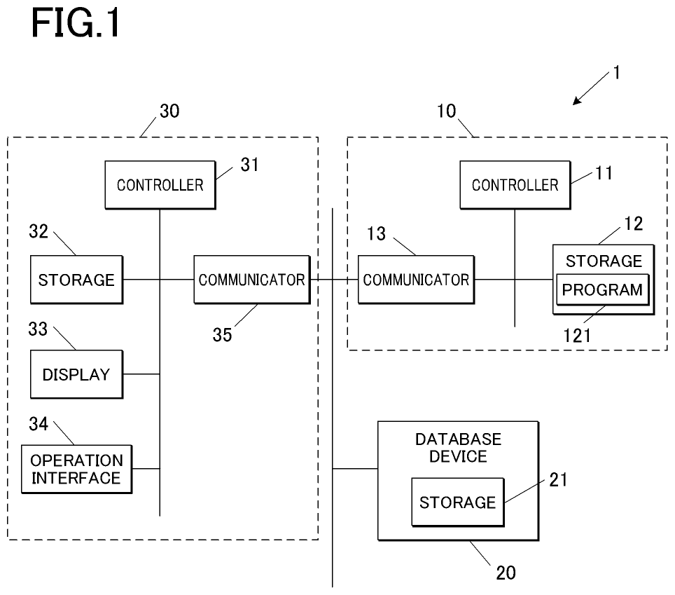

FIG. 1 is a block diagram illustrating the functional configuration of an idea generation support system 1 according to an embodiment.

The idea generation support system 1 includes a server device 10 (idea generation support device), a database device 20, and a terminal device 30.

The server device 10 includes a controller 11 (a hardware processor serving as an extractor, an obtainer, a generator, an image recognizer, a speech recognizer, and a calculator), a storage 12, and a communicator 13. The controller 11 includes a central processing unit (CPU) and a random access memory (RAM). The controller 11 serves as a processor that controls the entire operation of the server device 10 by performing various types of arithmetic processing.

The storage 12 stores programs executed by the controller 11 and setting data. The storage 12 temporarily stores various types of data input from the terminal device 30 and the resulting processed data. The storage 12 includes a non-volatile memory such as a hard disk drive (HDD) and/or a flash memory. The storage 12 may include a RAM or the like for temporarily storing large data for high-speed processing. The programs include programs for text analysis, image recognition, speech recognition, and an idea generation control process (described below). The programs may also include a program for updating a large number of objects (text objects, image objects, and audio objects) and their identification data stored and held in the database device 20.

The communicator 13 controls transmission of data to and reception of data from an external device according to a predetermined communication standard such as transmission control protocol/Internet protocol (TCP/IP). The communicator 13 is connected to an external device over a network. The communicator 13 may have a terminal that allows a direct communication with an external device (such as a peripheral device) via a universal serial bus (USB).

The database device 20 includes a storage 21 (memory) that stores and holds a large number of objects represented by text, images, audio and so on and their identification data in association with each other. The identification data may include the value of each semantic vector (described below). Further, a term, an image object, and audio data that correspond to each other (e.g., having the same meaning) are associated with each other whenever possible. That is, a recognized image object can be converted into text (such as a word). Also, content represented by text can be converted into an image object. The database device 20 may include a controller that controls reading and writing of the storage 21, and a communicator that controls communication with an external device.

The terminal device 30 receives an input from the user and provides an output to the user. The terminal device 30 includes a controller 31, a storage 32, a communicator 33, an operation interface 34, and a display 35. The controller 31 includes a CPU and a RAM. The controller 31 serves as a processor that controls the entire operation of the terminal device 30. The storage 32 includes a non-volatile memory, and stores various programs and data. The communicator 33 controls transmission of data to and reception of data from an external device according to a predetermined communication standard.

The operation interface 34 receives an input from the outside (such as the user), and outputs it as an input signal to the controller 31. The operation interface 34 includes, but not limited to, a keyboard, a mouse, and a touch sensor disposed on the display screen of the display 35, for example. The display 35 includes a display screen. The display 35 displays, on the display screen, the content corresponding to a control instruction from the controller 31. Examples of the display screen include, but not limited to, a liquid crystal display screen (LCD). The display 35 may include a light emitting diode (LED) lamp for indicating a specific state.

In the following, a description will be given of a semantic vector.

A semantic vector is a vector representing the meaning of any of objects corresponding to the content of various words, terms, images, and audio. The semantic similarity is represented by the distance (angular difference: e.g., cosine similarity) between semantic vectors. Further, it is possible to perform an operation between semantic vectors. For example, if the relationship between semantic vectors A and B (A−B) is the same as the relationship between the semantic vectors C and D (C−D), then A−B=C−D. The number of dimensions (a predetermined number of dimensions) may be any number of dimensions. In the case where machine learning is used, the number of dimensions may be a large number of dimensions, such as 100 to 1,000 dimensions. The characteristics in each axis direction do not have to be linguistically expressed.

In the idea generation support system 1, semantic vectors of many objects are calculated and held in advance based on a sufficient amount of text and graphics. Further, in the idea generation support system 1, image objects corresponding to text objects and audio objects that are verbalized as far as possible are held in the database device 20. That is, it is possible to obtain a corresponding image object based on an object verbalized as described above. Also, it is possible to convert an image object into a linguistically expressed text object by identifying and recognizing the image object.

In the idea generation support system 1, semantic vectors may be updated through machine learning, based on input data (sentences and the like) (operation performed as a calculator). Alternatively, semantic vectors may be updated only when learning data is provided according to a predetermined instruction. The learning algorithm for machine learning is not specifically limited. The learning algorithm may be either of the continuous skip-gram model or the continuous bag-of-words (CBOW) model that are usually used in Word2vec, or may be another model. The number of layers of the neural network does not have to be two, and a learning algorithm other than the neural network may be used.

Input data may be in any format. However, since text or images are used in the processing for semantic vectors, the input data may be limited to text data and image data. The input data may include audio data that can easily be converted into text data. Input data may be a combination of data of multiple types (data types).

Data of sentences, images, and the like often contains a plurality of objects (text such as sentences contains text objects, and images contain image objects). Each object has a meaning, and a semantic vector corresponding to the meaning is determined. Input data is decomposed into a plurality of text objects and image objects, and then each object and/or combinations of some of the objects are extracted. A semantic vector is obtained for each of the extracted objects from the learned data.

In the idea generation support system 1 of the present embodiment, when a plurality of decomposed objects, in particular, a plurality of sets of data are input, a semantic vector (resultant vector) indicating the content different from the content of the input data are generated based on at least some of semantic vectors of objects obtained from different sets of input data. Then, an object corresponding to the resultant vector is output as output data. A plurality of sets of output data (objects) are combined, or one or more sets of output data (objects) and objects contained in input data are combined to generate and output presentation data. When generating a resultant vector, predetermined arithmetic processing is performed on the obtained semantic vector so as to change the direction of a finally obtained semantic vector (resultant vector) from the direction of the original semantic vector, thereby attaining divergence from the content of the input data.

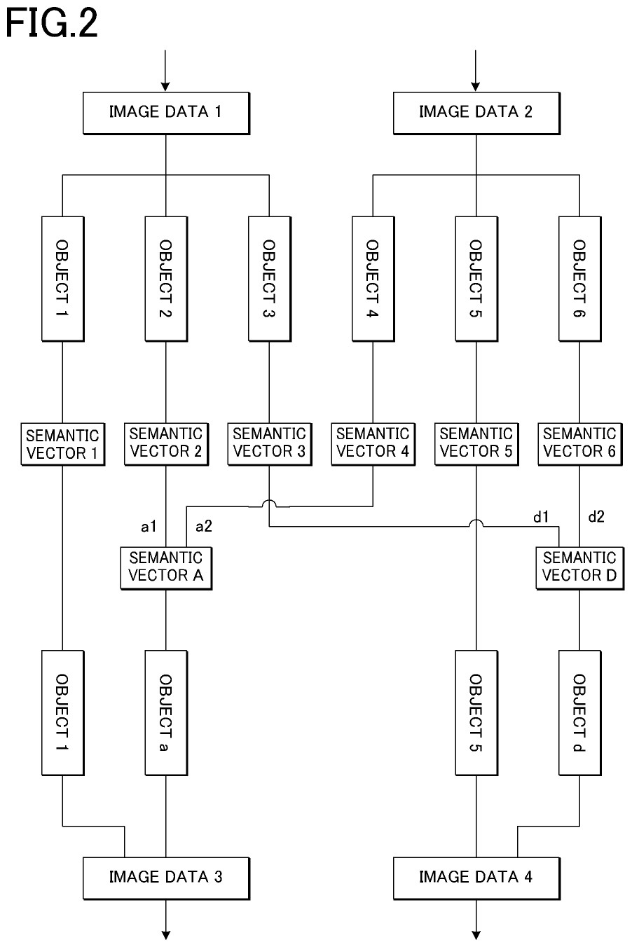

FIGS. 2 to 4 illustrate examples of processing for generating output data in the idea generation support system 1 of the present embodiment.

First Example of Processing

FIG. 2 illustrates an example of processing that generates output data by combining different semantic vectors. This example illustrates the case where output data and presentation data are obtained using two sets of image data (image data 1 and image data 2). The contour of an image and the like are detected from each of the image data 1 and the image data 2, using a predetermined image recognition technique. Then, the content is recognized from its shape, internal configuration, arrangement, and the like, based on a database obtained through machine learning, that is, the content stored in the storage 21. Based on the recognized content, objects are appropriately recognized from the contour so as to divide the image. As a result, image objects are extracted (operation performed as an image recognizer, and an extractor; extracting step). The term “object” as used herein is not limited to the minimum dividable unit as an object or a format. A plurality of extracted objects may include both a unit object and an object (partial composite image) in which a plurality of unit objects including that unit object are combined. For example, a plurality of extracted objects may include unit objects such as the “frame”, the “clock face”, the “hour hand”, the “minute hand”, and the “second hand” of a clock, and an object “pointer type clock” including all the unit objects. Examples of image data include a photographed image (including photographed data of painting, drawing, and text display), graphics data (such as CG), drawing (including vector data and dot data), and an image of text (such as a bit map). A set of image data may include two or more of these items, or may include other types of items. As for images of text, characters are converted into text data, and the content is recognized based on the obtained characters (character strings).

A semantic vector corresponding to the content is obtained for each object (operation performed as an obtainer; obtaining step). Predetermined arithmetic processing is performed to appropriately combine each two out of the obtained semantic vectors (in this example, out of some (plural), specifically four of six objects), and convert (change) the combined semantic vectors into a semantic vector (resultant vector) in another direction (operation performed as a generator; generating step). In this example, vector composition (arithmetic processing) is performed by combining a plurality of semantic vectors belonging to different sets of image data. Specifically, any of the four arithmetic operations (e.g., addition or subtraction) corresponding to the component of each vector is performed. Each of the semantic vectors to be subjected to the four arithmetic operations may be weighted. In this example, a semantic vector A is obtained by performing any of the four arithmetic operations on a semantic vector 2 (with a weight of a1) and a semantic vector 4 (with a weight of a2). Also, a semantic vector D is obtained by performing any of the four arithmetic operations on a semantic vector 3 (with a weight of d1) and a semantic vector 6 (with a weight of d2). Each of the combinations of the semantic vectors 2 and 4 and the combination of the semantic vectors 3 and 6 may be a combination of semantic vectors having directions that are away from each other (by a predetermined reference value or greater), in particular, a combination of the semantic vectors of objects farthest from each other. The distance between the semantic vectors may be, for example, the cosine similarity between the two semantic vectors.

The following describes the arithmetic processing on a semantic vector. As described above, the arithmetic processing is processing that converts the original one or more semantic vectors into another resultant vector. In the case of converting a plurality of semantic vectors into a single resultant vector, an operation that changes the direction of a resultant vector from the directions of all the semantic vectors may be performed.

The arithmetic processing may be processing that, while maintaining or making little changes to a component of a semantic vector having a great value (having an amount greater than a predetermine amount), changes the other components (that is, arithmetic processing configured such that the change rate of the component amount greater than or equal to a predetermined amount is less than the change rate of the component amount less than the predetermined amount). For example, the value of each component of a resultant vector may be determined such that the semantic vector before conversion and the resultant vector after conversion become orthogonal to each other by, while maintaining or making little changes to a predetermined number of (e.g., one) component amounts selected in descending order, or while maintaining or making little changes to a component amount greater than or equal to a predetermined reference value, greatly changing the other component amounts. Conversely, a resultant vector having a direction largely away from the direction of the semantic vector on the whole may be obtained by greatly changing the component amounts of a semantic vector having a value greater than a reference value or a predetermined number of component amounts selected in descending order (such that the change rate of the component amount greater than or equal to a predetermined amount is greater than the change rate of the component amount less than the predetermined amount).

The input data may include three or more sets of image data, and the presentation data may be obtained by combining the objects originating from these three or more sets of image data. In this case, the combination may be selected such that one of the combined objects is one representing the background, and the other objects are those representing the foreground in their original images.

An object a and an object d respectively having the closest direction (the smallest distance) to the obtained resultant vectors, that is, a sematic vector A and a semantic vector D are obtained as output data from the content stored in the database device 20 (operation performed as an output unit; outputting step). The semantic vectors whose directions have not been converted (in this example, a semantic vector 1 and a semantic vector 5) may be returned to the original objects (an object 1 and an object 5, respectively) as they are. In this example, the object a and the object d are obtained as image objects.

Image data 3 obtained by combining the object a and the object 1, both of which are image objects, is output as presentation data. Also, image data 4 obtained by combining the object d and the object 5 is output as presentation data. Each image object (output data) obtained from the resultant vector may be arranged in the same position as the arrangement position of any of the objects before conversion, or the average position (reference position). The object with a different shape may be used with that shape. The image object having a size different from the size before conversion may be adjusted to have the substantially same size as the image object before conversion. That is, in this example, the presentation data of the same data type as the input data is output. In the case where it is difficult to represent the concept represented by the resultant vector in the form of an image, such as when an abstract object or an intangible text object is obtained, presentation data in which text is attached to another image may be output instead of composing image data.

In this example, each object is exclusively assigned to a set of presentation data. However, if there is an object that is essential or fundamental to the concept, the object may be commonly included in different sets of presentation data (in this example, the image data 3 and the image data 4). Further, the direction of the semantic vector corresponding to an essential or fundamental object may be prevented from being changed.

Second Example of Processing

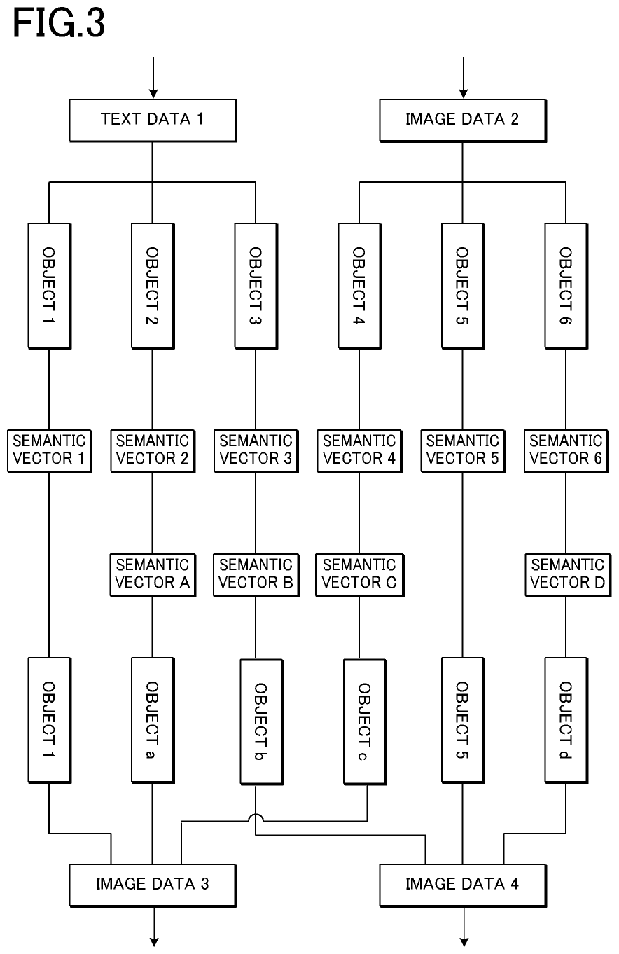

FIG. 3 illustrates an example of processing that generates output data by changing the direction of a single semantic vector to obtain another semantic vector. This example illustrates the case where output data is generated by combining text data and image data. Examples of text data include a document, a sentence, a phrase, a word, and a character. From these, words (in the case of idioms, each idiom may include a plurality of words) and/or characters (characters may include numbers and symbols) are detected, and extracted as objects each having a meaning (extractor). Objects are extracted from each of the text data and the image data, and their corresponding semantic vectors 1 to 6 are obtained (obtainer).

After that, in this example, arithmetic processing that converts the directions of some of the semantic vectors (semantic vectors 2 to 4, and 6) is performed (generator). The resultant vector may be determined by performing the arithmetic processing such that the vector directions before and after conversion greatly differ from each other, for example, such that the original semantic vector and the resultant vector become orthogonal to each other (e.g., the resultant vector may be calculated such that the inner vector with the original semantic vector becomes 0). Alternatively, the resultant vector may be determined such that the average or the minimum value of the angular difference (distance difference) between the resultant vector and each semantic vector becomes greater than or equal to a reference value.

Also, arithmetic processing that maintains some of the vector components may be performed in the same manner as described above. Semantic vectors having the closest direction to the respective converted semantic vectors (resultant vectors) are specified by referring to the data in the database device 20. Objects a to d corresponding to these semantic vectors are specified, and generated and output as output data (output unit). The objects a and b that are converted from text objects 2 and 3 and are output are image objects. An object 1 that is not converted from the semantic vector 1 is also converted from a text object into an image object corresponding thereto.

The objects 1, a, and c are combined to output image data 3 as presentation data. The objects 5, b, and d are combined to output image data 4 as presentation data. That is, an object 2 of the original text data 1 is converted into the objet a, and the object b corresponding to an object 3 is switched with the object c of the image data 2. An object 6 of the original image data 2 is converted into the objet d, and the object c corresponding to an object 4 is switched with the object b of the text data 1.

In this case, the object that is switched with another object among a plurality of sets of data may be arranged in a position where the other object has been arranged. The object c (output data that is output in accordance with the resultant vector) based on the object 3 of the text data 1 may be arranged in the place (position) where the object 4 of the image data 2 has been located. In the case where text data is converted into image data and output, the arrangement may be determined in accordance with the content of the original text, or may be simply arranged sequentially.

That is, when different types of data, namely, text data and image data, are combined, the different types of data are combined into data of only one of the data types (e.g., image data) so as to be output as presentation data. Alternatively, the different types of data may be combined into text data and output. For example, text objects such as nouns, verbs, and adjectives among text (sentences) may be converted into image objects so as to be combined with other image objects. Alternatively, nouns, verbs, and adjectives among text (sentences) may be replaced with nouns, verbs, and adjectives obtained by converting image objects into characters (text objects). The content of the output presentation data does not have to make sense on the whole. For example, the presentation data may include a series of nouns obtained by changing some of the word classes in the text. Also, if there are a noun, a verb, and an adjective having the same meaning and any of them can be selected without problems, the word class may be the same as that before the conversion of a semantic vector. Alternatively, for example, words may be converted preferentially into nouns to generate output data (object).

As for objects of text data, an idiom, an idiomatic expression, or the like may be extracted as a single object. Also, in the case of converting and replacing a part of text, division into objects may be performed in units of paragraphs or phrases, while adding an auxiliary, a particle (in Japanese grammar), or the like to a verb, a noun, an adjective, or the like as described above. When obtaining a semantic vector and performing arithmetic processing in this case, attached words such as an auxiliary and a particle do not have to be taken into account.

Third Example of Processing

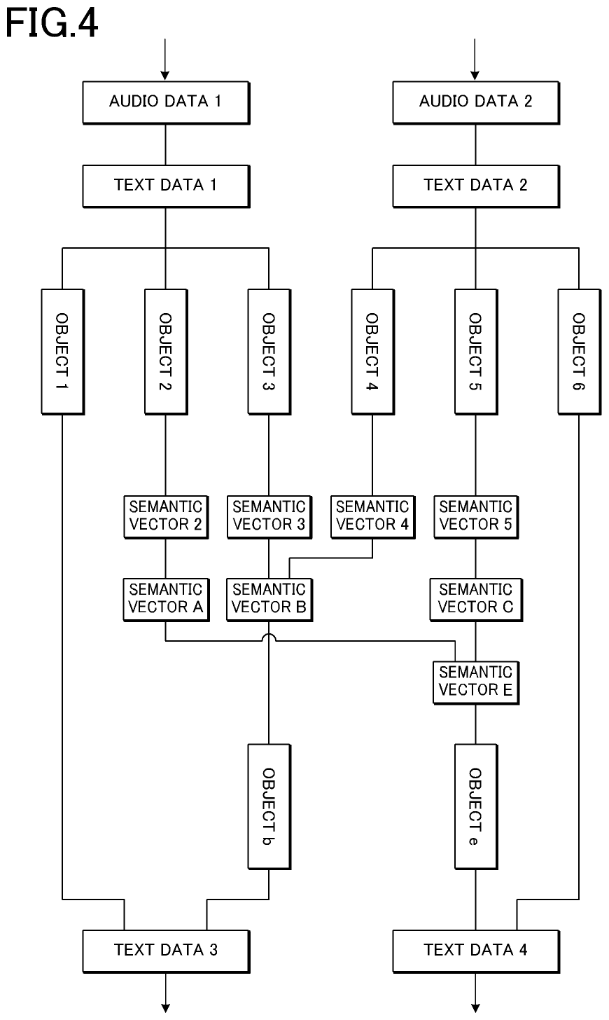

FIG. 4 illustrates an example of output data generation processing in which the first example of processing and the second example of processing are combined. This example illustrates the case where output data is generated by combining sets of audio data.

The content of each of audio data 1 and audio data 2 is converted into text data by a voice recognition program. If the audio data 1 and the audio data 2 are speech or conversation, the uttered speech is recognized as it is and is translated into text (converted into text data) (operation performed as a voice recognizer). The background sounds such as laughter and noise may be represented by terms representing the background sound (content). Also, a track of music, background music, or the like may be identified and the information about the track (such as track title, composer, and performer) may be translated into text data, or may be represented by information such as key, tempo, and the type of musical instruments.

After that, the content is recognized from the characters (character strings) of the text data, so that objects 1 to 6 are extracted (extractor). Of these, the object 1 and 6 on which an operation for obtaining a semantic vector is not to be performed may be used as they are without obtaining semantic vectors. Only semantic vectors 2 to 5 respectively representing the content of the other objects 2 to 5 are obtained (obtainer). In this example, the semantic vectors 3 and 4 are subjected to arithmetic processing to obtain a semantic vector B (resultant vector). Meanwhile, the semantic vectors 2 and 5 are individually subjected to arithmetic processing (converted) to obtain semantic vectors A and C. Thereafter, these semantic vectors A and C are subjected to any of the four arithmetic operations to obtain a semantic vector E (resultant vector) (operation performed as a generator). As in the case of the above-described other examples of processing that generates output data, the semantic vectors having the directions most away from each other (farthest from each other) among the plurality of held semantic vectors may be selected as the semantic vectors to be combined in the arithmetic processing. The arithmetic processing may be processing that performs an operation on a semantic vector to obtain a resultant vector having a direction largely away (having a great distance) from the direction of the semantic vector, or that maintains some of the vector components and selectively greatly changes some of the vector components.

The objects b and e closest to the respective semantic vectors B and E are specified and output as output data. Also, the object b is combined with the object 1 so that text data 3 is output as presentation data (output unit). The object e is combined with an object 6 so that text data 4 is output as presentation data. That is, the presentation data in this case does not have to be converted back to audio data to have the same data format as the input data, and the presentation data may be text data.

The presentation data is preferably data whose objects are easily recognizable by the user. For example, the presentation data may be text data, image data, audio data, or a combination of at least some of these types of data. In this example, audio data is converted into text data that allows easier recognition while considering the results.

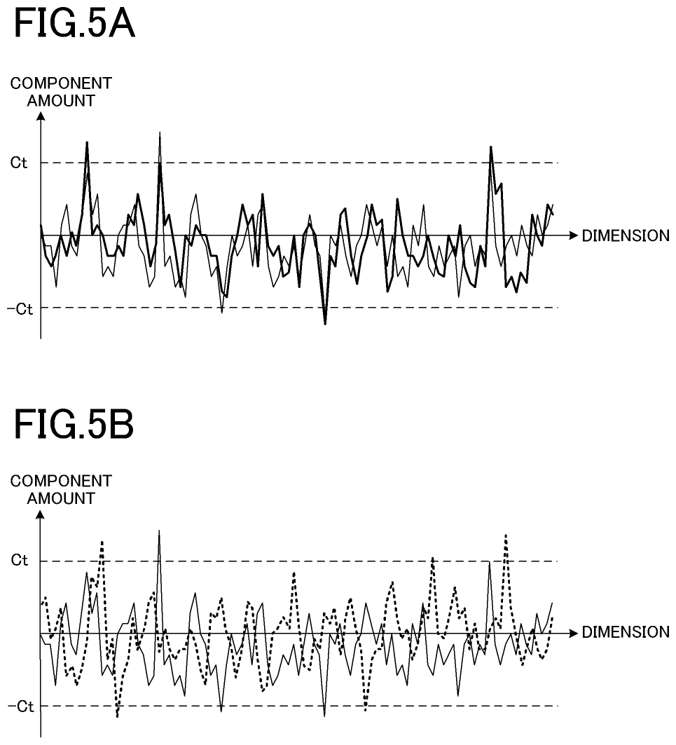

FIGS. 5A and 5B are diagrams each illustrating an example of the component amounts of multi-dimensional vectors. In each example, the component amounts of semantic vectors in 100 dimensions are individually plotted.

FIG. 5A illustrates an example in which the amounts of respective components of the thin line and the thick line are close to each other, and the directions of the semantic vectors are close to each other. FIG. 5B illustrates an example in which the absolute values and the signs of the thin solid line and the dotted line do not correspond to each other, and the directions of the semantic vectors are away from each other.

The amounts of two or three of the components exceed a reference value (Ct) indicated by the broken line. These components are the primary components of each semantic vector. If the semantic vector is converted while maintaining the primary components, the resultant semantic vector is similar or the same as the original semantic vector in terms of some concept or the type. Contrarily, if the semantic vector is converted such that the values of the primary components of the original semantic vector are reduced (greatly changed), the resultant semantic vector is different from the original semantic vector in terms of concept, and has little connection with the original semantic vector.

When combining objects corresponding to the semantic vectors after conversion (resultant vector), a combination may be selected such that the distance (direction) between the semantic vectors satisfies a predetermined criterion. In order to broaden the idea and attain divergence from the fixed scope, there may be a predetermined criterion indicating, for example, that a combination is selected so as to have a great difference (difference greater than or equal to a predetermined angle) in direction of the semantic vector between the objects in the presentation data and/or between the objects before and after replacement during generation of presentation data from the image of the original input data.

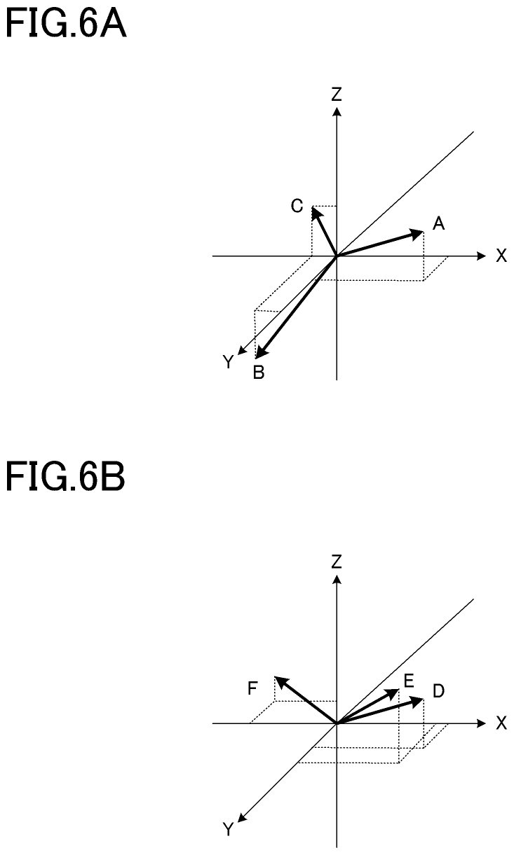

FIGS. 6A and 6B are schematic diagrams each illustrating an example of conversion and combination of semantic vectors. In this example, vectors are represented in three dimensions. However, in reality, vectors may be represented in a greater number of dimensions as described above.

As illustrated in FIG. 6A, a vector B is a vector whose components are greatly changed from the original vector A, in a plane orthogonal to the vector A. A vector C is a vector obtained by determining the components other than the Z component, while maintaining the Z component of the vector A, such that the vector C becomes orthogonal to the vector A. In this manner, even in the case of greatly changing the vector direction, various converted vectors are obtained according to the conditions.

As illustrated in FIG. 6B, vectors D and E are close in direction, and assumed to indicate the concepts similar to each other. These are often easily conceivable, and may be excluded from the subjects to be combined. The vector D and a vector F are greatly different from each other in X component and Y component, and are away from each other in direction. Accordingly, an unexpected combination may be obtained, and therefore the vector D and the vector F may be the subjects to be combined.

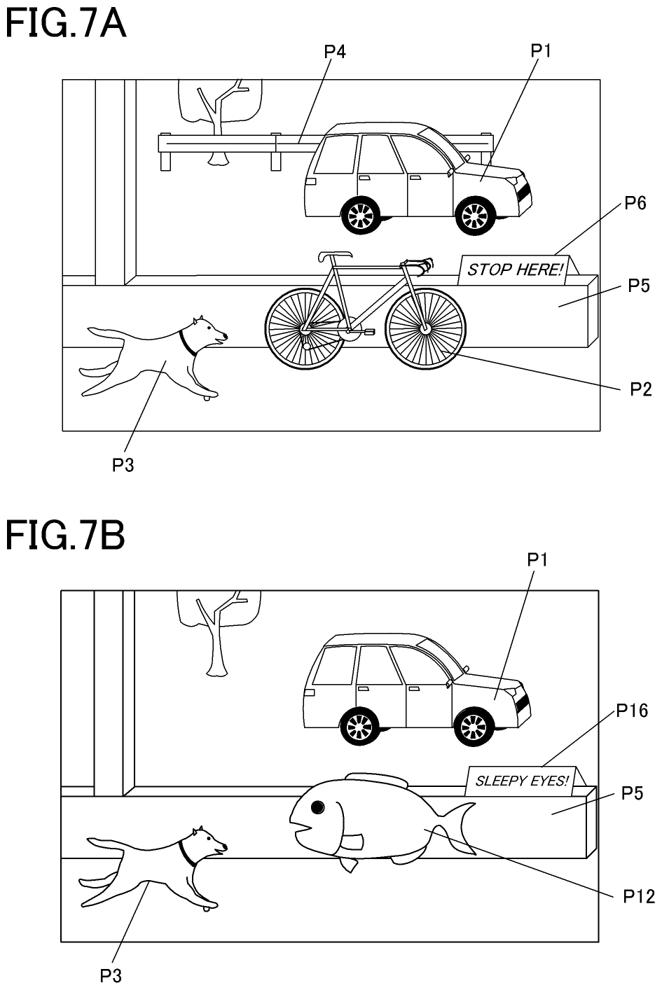

FIGS. 7A and 7B are diagrams illustrating an example of input and output image data.

As illustrated in FIG. 7A, an input image includes, for example, an automobile P1, a bicycle P2, and a dog P3. The input image further includes a rail P4, a wall P5, and a sign P6. By performing image recognition processing on the image data, these objects are identified and separated.

After extracting the objects from this image and obtaining their semantic vectors, some of the semantic vectors are appropriately converted. For instance, in this example, the direction of a semantic vector obtained by adding the bicycle P2 and the rail P4 is greatly changed, so that “fish” that is totally unrelated thereto is obtained. Also, two words “STOP HERE” on the sign P6 are converted into two words “SLEEPY EYES”. Based on these, as illustrated in FIG. 7B, an image object P12 corresponding to fish is displayed to replace the bicycle P2. Further, the character string in the sign P16 is converted into the one obtained by the conversion described above. That is, in order to obtain an idea that is not easily conceivable by many users, conversion is performed to greatly change the semantic vector according to the various conditions described above.

If the objects illustrated in FIG. 7A are arranged in connection with, for example, “enjoy running”, the idea may be broadened to, for example, swimming, eating, resting, playing at the river, and so on, by converting some of the objects in FIG. 7B.

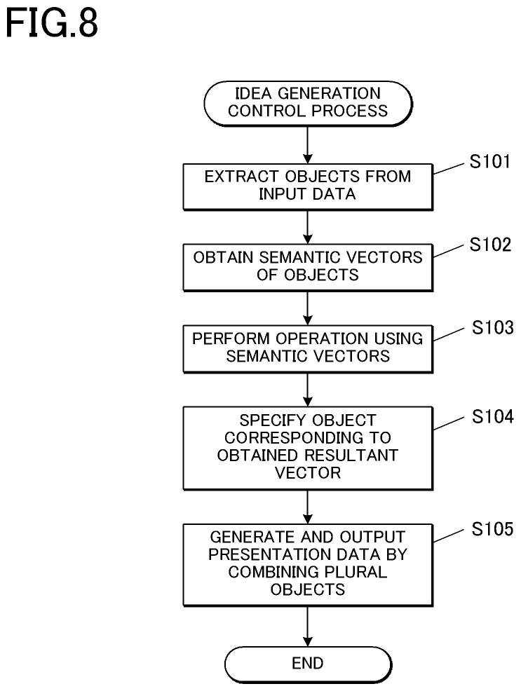

FIG. 8 is a flowchart illustrating the control steps performed by the controller 11 in an idea generation control process executed by the idea generation support system 1 of the present embodiment.

The idea generation control process is started when, for example, input data of a predetermined number or more sets of input data are input or specified, and the controller 11 detects an execution instruction that is input to the terminal device 30 by the user and obtained via the communicator 13. When the idea generation control process is started, the controller 11 extracts a plurality of objects from the input data (step S101; extractor). The controller 11 determines the type of the input data (image, text, audio, and so on), and performs processing for extracting objects using a method corresponding to the determination result as described above. The objects may include a combination of a plurality of smaller objects (unit objects), or may include both a small object and a combination including the small object, as described above.

The controller 11 recognizes the content of each object based on data held in the database device 20, and obtains semantic vectors corresponding to the recognized content (step S102; obtainer). The controller 11 performs an operation using the obtained semantic vectors (step S103; generator). As described above, the operation may be performed individually on each semantic vector, or the operation may be any of the four arithmetic operations performed on a plurality semantic vectors. Also, these operations may be combined. The semantic vectors to be subjected to the operation and the content of the operation may be determined based on the conditions desired by the user.

The controller 11 specifies the object (content) corresponding to the direction of the resultant vector obtained through the operation, and obtains the object (output data) (step S104; output unit). The controller 11 specifies the object by searching for the object (content) closest to the direction of the resultant vector from the database device 20. The controller 11 combines a plurality of objects obtained from the input data and generates and outputs presentation data different from the input data (step S105). As described above, if there are a plurality of sets of input data, the plurality of sets of input data may be combined. Also, a condition may be set with respect to the direction of the semantic vectors (including the resultant vectors) between the combined objects. Then, the controller 11 ends the idea generation control process.

As described above, the idea generation support system 1 of the present invention includes the controller 11. The controller 11 serves as: an extractor that extracts at least one object from input data; an obtainer that obtains a semantic vector having a direction and representing a meaning of the extracted object, based on the object; a generator that generates a semantic vector as a resultant vector having a direction different from the direction of the obtained semantic vector, by performing arithmetic processing based on the obtained semantic vector; and an output unit that outputs output data indicating an object corresponding to the generated resultant vector.

In this manner, some arithmetic processing is performed on a semantic vector, so that output data indicating an object obtained by greatly changing at least part of the content of the input data is output. Accordingly, it is possible to provide the user with a starting point for generating ideas in a variety of fields while preventing the user's thoughts from being focused around the content of the input data.

The controller 11 serving as an obtainer may obtain a plurality of semantic vectors respectively representing meanings of a plurality of semantic vectors. The arithmetic processing may include an operation that individually changes directions of the respective plurality of semantic vectors. That is, since the directions related to the plurality of objects are changed instead of changing the direction related to only one object of the input data, presentation data (output data) containing a wider variety of content than the original data is provided to the user.

The controller 11 serving as an output unit may output a plurality of output data corresponding to a plurality of resultant vectors respectively obtained from the plurality of semantic vectors. That is, the semantic vectors are converted into resultant vectors independently of each other, and presentation data including the individual objects (output data) corresponding to the respective resultant vectors is output. With this easy processing, the presentation data containing many objects with different content converted from the content of the original input data. In this way, the user can consider things from many points of view.

The controller 11 serving as a generator may obtain the resultant vector through arithmetic processing that combines a plurality of semantic vectors. That is, the resultant vector may be obtained from a single semantic vector, or may be obtained by performing an operation, specifically, any of the four arithmetic operations of addition, subtraction, multiplication and division, on a plurality of semantic vectors. A variety of degrees of combination may be selectively applied, and subtraction and multiplication may also be performed instead of performing only addition. Then, the user can easily find many starting points for getting concepts such as the concept obtained from a hardly conceivable combination and the concept obtained from a modification of an easily conceivable combination.

The controller 11 serving as a generator may specify the resultant vector as one of the semantic vectors to be combined. That is, an operation may be performed on a plurality of semantic vectors including a resultant vector that has been obtained from one or more semantic vectors through arithmetic processing, so as to calculate another resultant vector. Accordingly, it is possible to provide the user with a wider range of starting points for generating ideas by developing and expanding the idea from the initial concept.

The controller 11 serving as a generator may weight the plurality of semantic vectors in the arithmetic processing. That is, the degree of combination may be greatly varied so that the concepts derived from the concept of the original object are obtained from various angles. Furthermore, since these various patterns can easily mechanically be acquired in large numbers, combinations that may require serious study are easily extracted.

The controller 11 serving as an output unit may output the output data including an object that is same in semantic vector direction as any of the plurality of extracted objects. That is, the output data does not have to include only an object obtained by changing the direction of a semantic vector. Output data may include the original object, and an object of a type different from that of the original object (an image object changed from a character object). Accordingly, it is possible to output appropriate output data (presentation data) useful for generating ideas even when it is necessary to generate conditional ideas incorporating fresh ideas while maintaining the concept or the precondition of the original object whose semantic vector is not subjected to conversion.

The controller 11 serving as a generator may generate the resultant vector by combining a plurality of semantic vectors whose difference in direction is greater than a predetermined reference value. That is, based on semantic vectors originally having different directions, resultant vectors having further different directions are generated. Accordingly, it is possible to easily obtain objects expanded to a wide range, and provide a wider range of starting points for generating ideas to the user.

The arithmetic processing may include an operation that changes the direction of the semantic vector to a direction orthogonal to the semantic vector. Thus, the direction of the semantic vector is completely changed. Accordingly, it is possible to obtain an extreme combination that is unconceivable under normal circumstances, and provide a wider range of starting points for generating ideas from a broader perspective.

The arithmetic processing may include an operation configured such that, among component amounts of a predetermined number of dimensions of the semantic vector, a component amount that is greater than or equal to a predetermined amount has a change rate less than a change rate of a component amount that is less than the predetermined amount. That is, since a resultant vector is obtained by changing the direction of a semantic vector while maintaining the value of the component having a large component amount, it is possible to present the user with a variety of concepts while maintaining the primary concept of the original object. This reduces completely irrelevant outputs resulting from a meaningless combination.

The arithmetic processing may include an operation configured such that, among component amounts of a predetermined number of dimensions of the semantic vector, a component amount that is greater than or equal to a predetermined amount has a change rate greater than a change rate of a component amount that is less than the predetermined amount. Contrary to the above, an operation is performed such that the value of the component having a large component amount is greatly changed. Accordingly, it is possible to more reliably obtain an object greatly different from the original object and present data indicating the object to the user.

The controller 11 serving as an output unit may output image data, text data, audio data, or a combination of at least two of these types of data. Accordingly, it is possible to provide the user with data including sensory information to be received through sight and/or hearing. That is, even when an image object has a defined meaning, the image object is recognized in a wider variety of ways by the user. Accordingly, it is possible to provide the user with a broader range of starting points for generating ideas.

The input data may include data of at least one of data types, which are image data, text data, and audio data. Since input data may include image data and audio data for which content recognition technology has high accuracy, in addition to text data whose content is clear, it is possible to obtain output data including a wider variety of types of content.

The output data may be of the same data type as the input data. It is possible to provide data that is easily recognizable by the user by outputting output data of the same type as input data. Moreover, since an object whose semantic vector is not changed can be used as it is, the processing load is not increased more than necessary.

When the input data includes data of two or more data types, the controller 11 serving as a generator may generate the output data of any one of data types out of the two or more data types including image data, text data, and audio data. As multiple types of data may be input, the idea generation support system 1 can be used in a wider variety of ways, such as adding a keyword of a concept to an image or an image sound. Also, an output easily recognizable by the user is provided.

The controller 11 serving as an extractor may recognize and separate the object from the image data included in the input data. Accordingly, when an image is input as input data, it is possible to appropriately extract and accurately recognize a plurality of object from the image, and include the objects in output image or convert the objects to represent different content.

The image data may include at least any of a photographed image, painting, drawing, and an imaged character. That is, an image may be one that contains clearly separable objects, one that can be converted into characters as it is, one that contains connected or overlapping objects with unclear boundaries, or one that contains an object within which the photographing conditions vary (e.g., shadow). Accordingly, there is no need to impose strict conditions for acceptable image data, so that a variety of images such as a usual portrait image and a hand drawn image may be used.

The controller 11 serving as an obtainer may obtain the semantic vector based on content of text data converted from the imaged character included in the image data. That is, when input image data is an image of characters that can be directly converted into text, the text can be used as it is. Since processing load is less when processing is performed on image data than when processing is performed on text data, processing proceeds more smoothly.

The controller 11 serving as an extractor may extract the object (text object) from a character obtained by converting the audio data included in the input data into text data. It takes time and effort to separate, from audio data, a plurality of objects in the form of audio data, especially when there is an overlap. By converting audio data into text data, it is possible to easily separate objects, and reduce the processing load.

The controller 11 serving as an extractor may perform audio recognition that converts audio data into text data by identifying a word uttered in the audio data. The use of text data makes it easier to divide an utterance such as speech and conversation into words or paragraphs, and eliminates the effect of linking in pronunciation. This allows to perform processing with higher accuracy. Accordingly, it is possible to appropriately perform processing that extracts objects from the input data and obtain output data.

The object of the text data may include at least any of a noun, a verb, and an adjective. When each object is configured as a unit that includes an independent work, each object is reliably provided with a meaning. Whereas, when an object includes only an attached word, the object is provided with the meaning of the attached word. Moreover, each attached word has many meanings, resulting in large noise with respect to the original input content and the concept. That is, since the idea generation support system 1 extracts objects in the manner described above, it is possible to more appropriately provide output data that serves as a starting point for generating an idea.

The controller 11 serving as a generator may generate the output data preferentially including a noun among objects of the text data. A noun is relatively easily replaceable with words of other classes, and is often easily converted from text into image. Therefore, when a noun is preferentially included in output data, output of output data indicating an irrelevant action or state is reduced.

The text data may include any of text, a sentence, a phrase, a word, and a character. That is, the text data may be a long sentence or a short phrase. If something is expressed by a single Chinese character or the like, only the corresponding text object may be extracted, processed, and output. Accordingly, more appropriate output data may be generated by flexibly changing the unit of processing in accordance with input data.

The input data may include a plurality of sets of data such as image data and/or audio data, and the controller 11 serving as a generator may generate the output data based on objects obtained from the different sets of data. That is, objects (including resultant objects after conversion) obtained from different sets of data are combined. Accordingly, it is possible to widen the range of expression in the output data. Also, appropriate objects of multiple data types are combined to generate data of actual text and images, and the data is presented to the user. Accordingly, by combining a plurality of concepts and preconditions, it is possible to provide a wide range of combinations of data to the users who are not good at expanding ideas and give a starting point for generating ideas.

The controller 11 serving as a generator may generate the output data, by replacing an object extracted from a second set of data different from a first set of data among the plurality of sets of data, based on content corresponding to a resultant vector obtained through an operation performed on the semantic vector indicating an object extracted from the first set of data. That is, a resultant vector is obtained through extraction from one of a plurality of sets of data that is input based on the same concept and conversion, and then the content corresponding to the resultant vector is inserted into another set of data. This insertion is done by replacing a part of the other set of data. With this simple processing, it is possible to provide a variety of starting points for generating ideas as possible.

The idea generation support system 1 may further include the storage 21 (database device 20) that stores an object in association with a value of a semantic vector corresponding to the object, and the controller 11 serving as an obtainer may obtain the semantic vector indicating a meaning of the extracted object, from stored content in the storage 21.

Semantic vectors may be held in advance in association with words or the like in an object list. This makes it easy to obtain a semantic vector of multiple dimensions for each object of input data.

The controller 11 may further serve as a calculator that calculates the value of the semantic vector according to a predetermined machine learning algorithm. As a semantic vector is determined through machine learning, the positional relationship of meanings of a large number of objects are quantitatively determined without requiring work to analytically precisely determine the definition. In machine learning, the accuracy is improved by appropriately making updates based on newly input words. Therefore, processing is performed more accurately through learning after start of the operation of the idea generation support system 1, in addition to initially set data.

The controller 11 serving as a generator may specify, from the stored content in the storage 21, an object having a direction closest to a value of the resultant vector obtained through the operation performed on the semantic vector, and include the specified object in the output data. The direction of a resultant vector obtained as the operation result of a semantic vector does not necessarily indicate the direction of another object. Therefore, an object having the closest direction among the stored and held objects may be selected. Since numerical processing involves some errors as described above, it is possible to obtain an appropriate object with a satisfactory accuracy even when objects are handled in an approximate manner, and generate output data in which various objects are combined according to the purpose.

The server device 10 serving as the idea generation support device of the present embodiment includes the controller 11. The controller 11 serves as: an extractor that extracts a plurality of objects from input data; an obtainer that obtains a semantic vector having a direction and representing a meaning of the corresponding one of the objects, based on the extracted plurality of objects; a generator that generates a semantic vector as a resultant vector having a direction different from the direction of the input semantic vector, by performing arithmetic processing based on the obtained semantic vector; and an output unit that output data indicating an object corresponding to the generated resultant vector.

In this manner, at least part of the content of the input data is greatly changed using a semantic vector. Therefore, the server device 10 can provide a starting point for generating ideas in a variety of fields to the user while preventing the user's thoughts from being focused around the content of the input data.

A program 121 that causes a computer to implement the units described above may be installed in the computer. In this way, it is possible to generate and output a variety of sets of output data that help the user with expanding the ideas through software control, without having specific hardware.

The present invention is not limited to the embodiment described above, and various modifications may be made.

In the above embodiment, a plurality of objects are respectively extracted from a plurality of sets of data, thereby obtaining and converting a semantic vector, and generating output data. However, the number of sets of data is not limited as long as each of the input data and the output data includes a plurality of objects. For example, only one set of input image data may be used.

Further, in the above embodiment, only some of the semantic vector indicating respective objects are converted. However, all the semantic vectors may be converted into different resultant vectors. In this case, the output data may be totally different from the input data. Accordingly, various conditions described in the above embodiment may be applied when converting a semantic vector into a resultant vector.

Even in the case where not all the objects are converted into semantic vectors, all the objects included in the output data may be converted into semantic vectors.

In the above embodiment, if a semantic vector is converted to have a different direction, the output data is generated such that the original semantic vector is replaced with the converted semantic vector. However, the output data may include both the objects corresponding to the semantic vector before conversion and the semantic vector (resultant vector) after conversion. Furthermore, regardless of whether there is an object corresponding to the semantic vector before conversion, the content corresponding to the resultant vector may be located irrespective of the arrangement position of the object corresponding to the semantic vector before conversion, or may be located in the farthest possible position or a symmetric position (the symmetric point and the symmetric axis may be determined as desired). Alternatively, only the objects corresponding to the obtained resultant vectors may be separately output and presented.

It is not necessary to apply the same arithmetic pattern to all the sets of input data. For example, the arithmetic pattern may be determined for each set of input data, or one of a plurality of arithmetic patterns may be selected as desired or randomly. Also, a plurality of operation patterns may be applied to the same object so as to generate sets of output data including the respective operation results. That is, the number of sets of input data and the number of sets of output data do not have to be equal. Especially, by generating and outputting a greater number of sets of output data than the number of sets of input data, it is possible to provide the user with more starting points for generating ideas.

The operation performed for calculating a resultant vector is not limited, and may include a non-linear operation, a bit operation, and a logical operation. Also, the operation may include non-arithmetic processing such as random replacement of bit values. As long as the content of output data is changed based on a semantic vector, the semantic vector itself does not have to be converted into a resultant vector.

In the above embodiment, image data and audio data are processable. However, image data and audio data may not be processable. Also, for example, input data may include only text data, while output data may include image data.

In the above embodiment, the size of a divided object may be any size, and the same unit object may also be included in a larger object. However, the object division may be exclusive. Moreover, the rough size of an object may be specified. The degree of division of an object may be configurable.

In the above embodiment, the database device 20 (storage 21) and the server device 10 are separately provided. However, the server device 10 may include the storage 21, or the storage 21 may be connected to or controlled by the server device 10 as its peripheral device. The arithmetic control for updating the semantic vector stored in the storage 21 may be performed by a control unit of a processing device different from the server device 10. The processing for recognizing image data and audio data may be performed by another controller different from the controller 11. The other controller may be included in a device other than the server device 10 of the idea generation support system 1.

Image data and audio data may be received in the form of digitized data via the communicator 13, or may be directly received via a scanner, a microphone, or the like.

In the above embodiment, the semantic vector is calculated according to a predetermined machine learning algorithm, and a correspondence relationship with an object is determined and stored. However, a predetermined transformation formula may be held.

In the above description, the storage 21 having an auxiliary storage device such as an HDD or other non-volatile memories is illustrated as a computer readable medium storing the program 121 for the processing operation by the controller 11 of the present invention. However, the present invention is not limited thereto. Portable recording media such as a CD-ROM and a DVD are applicable as other computer-readable media. Carrier wave is also applicable to the present invention as a medium for providing data of the program according to the present invention through a communication line.

Further, the specific configuration, structure, material, operation content and steps, and so on described in the above embodiments may be modified within the scope of the present invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese patent application No. 2019-104145, filed on Jun. 4, 2019, is incorporated herein by reference in its entirety.

What is claimed is:

1. An idea generation support system comprising:
a hardware processor configured to perform:
extracting at least one object from input data;
obtaining a semantic vector having a direction and representing a meaning of the extracted object, based on the object;
generating a semantic vector as a resultant vector having a direction different from the direction of the obtained semantic vector, by performing arithmetic processing based on the obtained semantic vector; and
outputting output data indicating an object corresponding to the generated resultant vector.

2. The idea generation support system according to claim 1, wherein:
the obtaining includes obtaining plural of the semantic vectors respectively representing meanings of plural of the objects; and
the arithmetic processing includes an operation that individually changes directions of the respective plurality of semantic vectors.

3. The idea generation support system according to claim 2, wherein the outputting includes outputting plural sets of the output data corresponding to plural of the resultant vectors respectively obtained from the plurality of semantic vectors.

4. The idea generation support system according to claim 1, wherein the generating includes obtaining the resultant vector through arithmetic processing that combines plural of the semantic vectors.

5. The idea generation support system according to claim 4, wherein the generating includes specifying the resultant vector as one of the semantic vectors to be combined.

6. The idea generation support system according to claim 5, wherein the generating includes weighting the plurality of semantic vectors in the arithmetic processing.

7. The idea generation support system according to claim 1, wherein the outputting includes outputting the output data including an object that is same in semantic vector direction as any of the extracted objects.

8. The idea generation support system according to claim 1, wherein the generating includes generating the resultant vector by combining the semantic vectors whose difference in direction is greater than a predetermined reference value.

9. The idea generation support system according to claim 1, wherein the arithmetic processing includes an operation that changes the direction of the semantic vector to a direction orthogonal to the semantic vector.

10. The idea generation support system according to claim 1, wherein the arithmetic processing includes an operation configured such that, among component amounts of a predetermined number of dimensions of the semantic vector, a component amount that is greater than or equal to a predetermined amount has a change rate less than a change rate of a component amount that is less than the predetermined amount.

11. The idea generation support system according to claim 1, wherein the arithmetic processing includes an operation configured such that, among component amounts of a predetermined number of dimensions of the semantic vector, a component amount that is greater than or equal to a predetermined amount has a change rate greater than a change rate of a component amount that is less than the predetermined amount.

12. The idea generation support system according to claim 1, wherein the outputting includes outputting the output data indicating objects of data of any one of data types, or combined data of at least two of the data types, the data types including image data, text data, and audio data.

13. The idea generation support system according to claim 1, wherein the input data includes data of at least one of data types, the data types including image data, text data, and audio data.

14. The idea generation support system according to claim 13, wherein the output data is of a same data type as the input data.

15. The idea generation support system according to claim 13, wherein when the input data includes data of two or more data types, the outputting includes outputting the output data of any one of data types out of the two or more data types, the data types including image data, text data, and audio data.

16. The idea generation support system according to claim 13, wherein the extracting includes recognizing and separating the object from the image data included in the input data.

17. The idea generation support system according to claim 13, wherein the image data includes at least any of a photographed image, painting, drawing, and an imaged character.

18. The idea generation support system according to claim 17, wherein the obtaining includes obtaining the semantic vector based on content of text data converted from the imaged character included in the image data.

19. The idea generation support system according to claim 13, wherein the extracting includes extracting the object from a character obtained by converting the audio data included in the input data into text data.

20. The idea generation support system according to claim 19, wherein the extracting includes converting the audio data into the text data by identifying a word uttered in the audio data.

21. The idea generation support system according to claim 13, wherein the object of the text data includes at least any of a noun, a verb, and an adjective.

22. The idea generation support system according to claim 21, wherein the generating includes generating the output data preferentially including a noun among objects of the text data.

23. The idea generation support system according to claim 13, wherein the text data includes any of a document, a sentence, a phrase, a word, and a character.

24. The idea generation support system according to claim 13, wherein:
the input data includes a plurality of sets of data; and
the generating includes generating the output data based on objects obtained from the different sets of data.

25. The idea generation support system according to claim 24, wherein the generating includes generating the output data, by replacing an object extracted from a second set of data different from a first set of data among the plurality of sets of data, based on content corresponding to a resultant vector obtained through an operation performed on the semantic vector indicating an object extracted from the first set of data.

26. The idea generation support system according to claim 1, further comprising:
a memory that stores an object in association with a value of a semantic vector corresponding to the object;
wherein the obtaining includes obtaining the semantic vector indicating a meaning of the extracted object, from stored content in the memory.

27. The idea generation support system according to claim 26, wherein the hardware processor further performs:
calculating the value of the semantic vector according to a predetermined machine learning algorithm.

28. The idea generation support system according to claim 26, wherein the generating includes specifying, from the stored content in the memory, an object having a direction closest to a value of the resultant vector obtained through the operation performed on the semantic vector, and including the specified object in the output data.

29. An idea generation support device comprising:
a hardware processor configured to perform:
extracting at least one object from input data;
obtaining a semantic vector having a direction and representing a meaning of the extracted object, based on the object;
generating a semantic vector as a resultant vector having a direction different from the direction of the obtained semantic vector, by performing arithmetic processing based on the obtained semantic vector; and
outputting output data indicating an object corresponding to the generated resultant vector.

30. A non-transitory recording medium storing a computer-readable program, the program causing a computer to perform:
extracting at least one object from input data;
obtaining a semantic vector having a direction and representing a meaning of the extracted object, based on the object;
generating a semantic vector as a resultant vector having a direction different from the direction of the obtained semantic vector, by performing arithmetic processing based on the obtained semantic vector; and
outputting output data indicating an object corresponding to the generated resultant vector.
